(19) United States
(12) Patent Application Publication
(10) Pub. No.: US 2003/0207757 A1
(43) Pub. Date: Nov. 6, 2003

(54) Catalyst composition comprising metallocene compound having bulky cycloalkyl-substituted cyclopentadienyl ligand, and process for olefin polymerization using the same

(75) Inventors: Sah Mun Hong, Daejeon-City (KR); Tae Soo Hwang, Daejeon-City (KR); Young Jae Jun, Daejeon-City (KR); Sung Woo Kang, Daejeon-City (KR); Byoung Keel Sohn, Daejeon-City (KR); Jin Sook Oh, Daejeon-City (KR); Hyun Ki Youn, Daejeon City (KR)

Correspondence Address: STAAS & HALSEY LLP, SUITE 700, 1201 NEW YORK AVENUE, N.W., WASHINGTON, DC, 20005, US

(73) Assignee: Daelim Industries Co., Ltd., Seoul (KR)

(21) Appl. No.: 10/424,858

(22) Filed: Apr. 29, 2003

(30) Foreign Application Priority Data
Apr. 30, 2002 (KR) 2002-0023801
Dec. 31, 2002 (KR) 2002-0088222

(51) Int. Cl. B01J 27/135

(52) U.S. Cl. 502/227; 502/132

(57) ABSTRACT

A catalyst composition, suitable for polymerization of low-density and high-molecular weight polyolefin, comprising unsymmetrical unabridged metallocene compound and an aluminoxane is disclosed, wherein the metallocene compound and the aluminoxane are uniformly deposited on a porous support by using an oscillatory wave having the frequency of 20 to 500 kHz, and the activity of the catalyst composition increases when hydrogen is introduced in the polymerization of olefin. The catalyst composition includes a metallocene compound represented by (R¹CpR²)(Cp′R³)MX₂ for polymerization of olefin, and an aluminoxane, wherein Cp is a cyclopentadienyl radical; Cp′ is a radical having a cyclopentadienyl moiety; R¹ is a radical selected from cyclohydrocarbyl radicals having 3 to 11 carbon atoms; R² and R³ are one or more substituents substituted on Cp and Cp′, respectively; M is a transition metal of Group 4B, 5B, or 6B of the Periodic Table; and X can be the same or different, and is a radical selected from halogen, alkyl, aryl, alkenyl, alkylaryl, arylalkyl, alkoxy, and aryloxy radical having 1 to 20 carbon atoms, and the metallocene compound and the aluminoxane are deposited on porous support.

### FIELD OF THE INVENTION

The present invention relates to a catalyst composition comprising metallocene compound having bulky cycloalkyl-substituted cyclopentadienyl ligand, and more particularly, to a catalyst composition comprising unsymmetrical unbridged metallocene compound which is suitable for polymerization of low-density and high-molecular weight polyolefin, and whose activity increases by hydrogen introduced in the polyolefin polymerization, and a process for olefin polymerization using the same.

### BACKGROUNDS OF THE INVENTION

Catalysts including transition metal are generally used for olefin polymerizations. For example, German patent Nos. 2,608,933 and 3,007,725 disclose a catalyst composition for olefin polymerization including a metallocene compound having a transition metal of Group 4B of the Periodic Table, such as zirconium, titanium, or hafnium and cyclopentadienyl ligand, and a co-catalyst such as an methylaluminoxane. The exemplary cyclopentadienyl ligand disclosed in the conventional arts includes cyclopentadiene, indene, fluorene, substituted cyclopentadiene, substituted indene, substituted fluorene, etc. Various metallocene compounds having the cyclopentadienyl ligand can be used to form catalyst systems for the olefin polymerization, and it is well known that the suitability of the metallocene compound as a polymerization catalyst depends on the chemical structures of the metallocene compounds. For example, the size and position of the substituent substituted on the cyclopentadienyl ligand may affect the activity, the stereoselectivity, and the stability of the catalyst, and the properties of the produced polymer. Recently, it has been found that the catalyst system comprising substituted cyclopentadienyl metallocene having zirconium as the transition metal, and methylaluminoxane, shows a high activity in olefin polymerization, which is disclosed in various prior arts, such as European Patent No. 129,368, U.S. Pat. Nos. 4,874,880 and 5,324,800, and Makromol. Chem. Rapid Commun., 4,417(1983). etc.

Exemplary metallocene compounds having hydrocarbyl substituted cyclopentadienyl ligand and zirconium include bis(alkylcyclopentadienyl)zirconium dichloride (wherein, alkyl is methyl, ethyl, isopropyl, tert-butyl or trimethylsilyl)(J. Chem. Soc. Dalton Trans., 805(1981)), bis(pentamethylcyclopentadienyl)zirconium dichloride (J. Amer. Chem. Soc., 100, 3078(1978)), (pentamethylcyclopentadienyl)(cyclopentadienyl)zirconium dichloride (J. Amer. Chem. Soc., 106, 6355(1984)), bis(di, tri, or tetra alkyl-cyclopentadienyl)zirconium dichloride (U.S. Pat. No. 4,874,880), and such metallocene compounds are referred to as symmetrical unbridged metallocenes having two identical cyclopentadienyl ligands. Exemplary unsymmetrical unbridged metallocene compounds include (cyclopentadienyl)(indenyl) and (cyclopentadienyl)(fluorenyl) metallocene (U.S. Pat. No. 5,541,272); and (substituted indenyl)(cyclopentadienyl) metallocene (U.S. Pat. Nos. 5,223,467 and 5,780,659). The unsymmetrical unbridged (cyclopentadienyl)(indenyl)zirconium dichloride disclosed in U.S. Pat. No. 5,541,272 is regarded to have better activity than the symmetrical unbridged bis(indenyl)zirconium dichloride or bis(cyclopentadienyl)zirconium dichloride.

However, most of the conventional metallocene compounds is symmetrical unbridged bis(cyclopentadienyl) metallocene compounds, and unsymmetrical unbridged (substituted or unsubstituted indenyl)(unsubstituted cyclopentadienyl) metallocene compounds are used less frequently. The conventional unbridged metallocene compounds do not have sufficient activity in commercial or industrial olefin polymerization process, and is difficult to produce the high molecular weight polyolefin. Furthermore, the activity of the conventional metallocene compound decreases by hydrogen and co-monomer which are introduced in the olefin polymerization reaction to control the properties, such as molecular weight or density, of the produced polyolefin. Thus, the properties of the produced polyolefin are not satisfactory, and operation of the polymerization reactor is not easy with the conventional metallocene compounds.

### SUMMARY OF THE INVENTION

Therefore, the present invention is to provide a catalyst composition comprising unsymmetrical unbridged metallocene compound which is suitable for commercial and industrial polymerization process and overcomes the disadvantages of the conventional catalyst composition. Other object of the present invention is to provide a catalyst composition comprising unsymmetrical unbridged metallocene compound whose activity is maintained even when hydrogen or co-monomer are introduced in the polymerization reaction, and a process for olefin polymerization using the same. Another object of the present invention is to provide a catalyst composition comprising unsymmetrical unbridged metallocene compound which is suitable for polymerization of low-density and high-molecular weight polyolefin, and a process for olefin polymerization using the same. Another object of the present invention is to provide a catalyst composition comprising unsymmetrical unbridged metallocene compound whose activity does not decrease due to hydrogen or co-monomer, and on the contrary, whose activity increases by the introduced hydrogen, and which is suitable for producing a high-molecular weight polyolefin stably and efficiently even when producing low-density polyolefin by introducing a co-monomer such as hexene-1, and a process for olefin polymerization using the same.

To achieve these objects, the present invention provides a catalyst composition for polymerizing olefins comprising a metallocene compound represented by chemical formula 1, and an alumoxane represented by chemical formula 2 or 3, wherein the metallocene compound and the alumoxane are uniformly deposited on a porous support by using an oscillatory wave having the frequency of 20 to 500 kHz, and the activity of the catalyst composition increases when hydrogen is introduced in the polymerizing olefin.

[Chemical formula 1]

(R¹CpR²)(Cp′R³)MX₂

wherein, Cp is a cyclopentadienyl radical; Cp′ is a radical having a cyclopentadienyl moiety, preferably a cyclopentadienyl, an indenyl or a fluorenyl radical; R¹ is a radical selected from cyclohydrocarbyl radicals having 3 to 11 carbon atoms; R² and R³ are one or more substituents substituted on Cp and Cp′, respectively, and the substituents can be the same or different, and are hydrogen, phosphine, amino, alkyl, alkoxy, alkyl amino, dialkyl amino, alkoxy-alkyl, aryl, aryloxy-alkyl, alkenyl, alkylaryl, or arylalkyl radical having 1 to 20 carbon atoms; M is a transition metal of Group 4B, 5B, or 6B of the Periodic Table; and X can be the same or different, and is a radical selected from halogen, alkyl, aryl, alkenyl, alkylaryl, arylalkyl, alkoxy, and aryloxy radical having 1 to 20 carbon atoms.

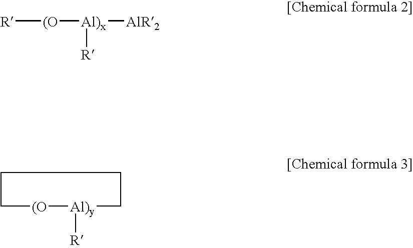

wherein, each R′ is the same or different and is a hydrocarbyl radical having 1 to 10 carbon atoms, x is an integer in the range of 1 to 50, and y is an integer in the range of 3 to 50.

The present invention further provides a process for olefin polymerization comprising the step of polymerizing ethylene with the catalyst composition in the presence of one or more co-monomer. The polymerization of olefins using the catalyst of the invention can be carried out in a solution, slurry or gas phase in the presence of hydrogen to control the molecular weight of the polymer.

### DETAILED DESCRIPTION OF THE INVENTION

For the better understanding of the present invention, reference will now be made in detail to the following disclosures.

The catalyst composition comprising a metallocene compound having bulky cycloalkyl-substituted cyclopentadienyl ligand according to the present invention includes a metallocene compound of chemical formula 1 having a substituted or unsubstituted cyclopentadienyl ligand (R¹CpR²), which has a cycloalkyl substituent, a substituted or unsubstituted ligand having a cyclopentadienyl moiety (Cp′R³), and transition metal (M) to which the ligands are bonded, and an alumoxane of chemical formula 2 or 3.

The metallocene compounds of chemical formula 1 can be prepared by a conventional process. For example, as shown in following reaction 1, the compound can be prepared by reacting an alkali metal salt of the cycloalkyl substituted cyclopentadienyl compound (M′(R¹CpR²)) with a suitable transition metal compound ((Cp′R³) MX₃).

[Reaction 1]

M′(R¹CpR²)+(Cp′R³)MX₃→(R¹CpR²)(Cp′R³)MX₂+M′X

The cycloalkyl substituent (R¹) which is substituted on the cyclopentadienyl radical (Cp) is preferably selected from cyclohydrocarbyl radicals having 3 to 11 carbon atoms, more preferably cyclopentyl or cyclohexyl radical. The alkali metal salt of the cycloalkyl (R¹) substituted cyclopentadienyl compound M′(R¹CpR²) can also be prepared by a conventional process, and typically can be prepared by reacting a cycloalkyl substituted cyclopentadienyl compound with a metallizing reagent, which is a compound having an alkali metal (M′) such as lithium, sodium, potassium, etc., for example, butyl lithium. Generally, the conversion of cycloalkyl substituted cyclopentadienyl compound to alkali metal compounds is carried out at a temperature of −78 to 100° C. for 2 to 40 hours in the presence of a solvent and inert atmosphere such as nitrogen atmosphere. Examples of the solvent include diethylether, diethyleneglycol diethylether, tetrahydrofuran(THF), pentane, hexane, heptane, toluene and the like, and the preferable solvent is diethylether, tetrahydrofuran(THF), pentane, or hexane. The obtained alkali metal salt of cycloalkyl substituted cyclopentadienyl compound can be directly used in the next reaction step, or can be obtained in the form of a solid powder organometallic compound to be used for the next step.

M of (Cp′R³)MX₃ is a transition metal of Group 4B, 5B, or 6B of the Periodic Table, preferably titanium, zirconium or hafnium selected from the Group 4B metals. Cp′ is an organic radical having a cyclopentadienyl moiety, preferably cyclopentadienyl, indenyl, 4,5,6,7-tetrahydro-1-indenyl, fluorenyl radical or the like. R² and R³ are one or more substituents substituted on Cp and Cp′, respectively, and the substituents can be the same or different, and are hydrogen, phosphine, amino, alkyl, alkoxy, alkyl amino, dialkyl amino, alkoxy-alkyl, aryl, aryloxy-alkyl, alkenyl, alkylaryl, or arylalkyl radical having 1 to 20 carbon atoms. X can be the same or different, and is a radical selected from halogen, alkyl, aryl, alkenyl, alkylaryl, arylalkyl, alkoxy, and aryloxy radical having 1 to 20 carbon atoms, preferably Cl, Br or I, and more preferably Cl.

Preferably, the reaction of M′(R¹CpR²) and (Cp′R³) in reaction 1 is carried out by dissolving the equal chemical equivalents of the reactants in solvent, and then by slowly mixing the prepared solution. The reaction is carried out in the presence of a solvent at a temperature of −78 to 100° C. for 1 hour to 3 days. Examples of the solvent include diethylether, diethyleneglycol diethylether, tetrahydrofuran(THF), dichloromethane and the like. The reaction product produced by the reaction 1 is preferably used after purification by such method as solvent removal, filtration, re-crystallization, sublimation and the like.

In the metallocene compound of chemical formula 1, the representative examples of (R¹CpR²) include (cyclopentyl cyclopentadienyl), (1-methyl-3-cyclopentyl cyclopentadienyl), (1-ethyl-3-cyclopentyl cyclopentadienyl), (1-butyl-3-cyclopentyl cyclopentadienyl), (cyclohexyl cyclopentadienyl), (1-methyl-3-cyclohexyl cyclopentadienyl), (1-ethyl-3-cyclohexyl cyclopentadienyl), (1-butyl-3-cyclohexyl cyclopentadienyl), (cyclohexylmethylenyl cyclopentadienyl), (cycloheptyl cyclopentadienyl), ((4-methylcyclohexyl) cyclopentadienyl), and (cyclohexylethylenyl cyclopentadienyl) radical, and the representative examples of (Cp′R³) include cyclopentadienyl, indenyl, 4,5,6,7-tetrahydro-1-indenyl, fluorenyl radical and pentamethylcyclopentadienyl radical.

Specific examples of the metallocene compound having a zirconium, titanium or hafnium transition metal, which can be used in the catalyst composition of the present invention, are as follows. Examples of the compound, in which (R¹CpR²) is a cycloalkyl substituted cyclopentadienyl ligand, and the transition metal is a zirconium, includes (cyclopentyl cyclopentadienyl)(cyclopentadienyl)zirconium dichloride, (1-methyl-3-cyclopentyl cyclopentadienyl)(cyclopentadienyl)zirconium dichloride, (1-ethyl-3-cyclopentyl cyclopentadienyl)(cyclopentadienyl)zirconium dichloride, (1-butyl-3-cyclopentyl cyclopentadienyl)(cyclopentadienyl)zirconium dichloride, (cyclopentyl cyclopentadienyl)(pentamethylcyclopentadienyl)zirconium dichloride, (1-methyl-3-cyclopentyl cyclopentadienyl)(pentamethylcyclopentadienyl)zirconium dichloride, (1-ethyl-3-cyclopentyl cyclopentadienyl)(pentamethylcyclopentadienyl)zirconium dichloride, (1-butyl-3-cyclopentylcyclopentadienyl) (pentamethylcyclopentadienyl) zirconium dichloride, (cyclohexyl cyclopentadienyl)(cyclopentadienyl)zirconium dichloride, (1-methyl-3-cyclohexyl cyclopentadienyl)(cyclopentadienyl)zirconium dichloride, (1-ethyl-3-cyclohexyl cyclopentadienyl)(cyclopentadienyl)zirconium dichloride, (1-butyl-3-cyclohexyl cyclopentadienyl)(cyclopentadienyl)zirconium dichloride, (cyclohexyl cyclopentadienyl)(pentamethylcyclopentadienyl)zirconium dichloride, (1-methyl-3-cyclohexyl cyclopentadienyl)(pentamethylcyclopentadienyl)zirconium dichloride, (1-ethyl-3-cyclohexyl cyclopentadienyl)(pentamethylcyclopentadienyl)zirconium dichloride, (1-butyl-3-cyclohexyl cyclopentadienyl)(pentamethylcyclopentadienyl) zirconium dichloride, (cyclohexylmethylenyl cyclopentadienyl) (cyclopentadienyl)zirconium dichloride, (cycloheptyl cyclopentadienyl) (cyclopentadienyl)zirconium dichloride, (1-methyl-3-cycloheptyl cyclopentadienyl)(cyclopentadienyl)zirconium dichloride, (1-ethyl-3-cycloheptyl cyclopentadienyl)(cyclopentadienyl)zirconium dichloride, (1-butyl-3-cycloheptyl cyclopentadienyl)(cyclopentadienyl)zirconium dichloride, (cyclohexylethylenyl cyclopentadienyl)(cyclopentadienyl)zirconium dichloride, and the analogue compound thereof. The metallocene compounds having titanium or hafnium transition metal can be listed in the similar way, and the metallocene compounds having other cycloalkyl substituent can be listed in the similar way. One kind of the metallocene compounds can be used in the present invention, and two or more metallocene compounds can be used in mixed form in the present invention.

In order to stably and effectively polymerize the low-density and high molecular weight polyolefin while preventing the activity decrease of the catalyst due to hydrogen or co-monomer introduced in the olefin polymerization, the catalyst composition of the present invention includes the unsymmetrical unbridged metallocene compound and a suitable co-catalyst. As the co-catalysts, methylaluminoxane (MAO), modified methylaluminoxane (MMAO), and the like can be used. The methylaluminoxane (MAO) or the modified methylaluminoxane (MMAO) co-catalyst can be produced by adding water to trialkylaluminium, or by reacting trialkylaluminium with hydrocarbon compound containing water or an inorganic hydrated salt containing water. The aluminoxane is generally in the form of a linear or a cyclic aluminoxane as shown in chemical formulas 2 and 3. The linear aluminoxane or the cyclic aluminoxane may be used as such or in a mixed form, and is commercially available in the dissolved state in various hydrocarbon solutions. The preferred solvent for aluminoxane solution is aromatic hydrocarbons, and the more preferred solvent is toluene.

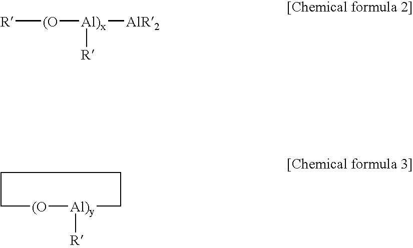

In chemical formula 2 and 3, each R′ is the same or different hydrocarbyl radical, preferably a linear or a branched alkyl radical having 1 to 10 carbon atoms, and more preferably most of R′ is methyl group; x is an integer in the range of 1 to 50, preferably an integer in the range of 10 to 40; and y is an integer in the range of 3 to 50, preferably an integer in the range 10 to 40.

The amount of the co-catalyst used with the metallocene compound of the present invention can be varied over a wide range. The preferred molar ratio of the aluminum in the aluminoxane to the transition metal in the metallocene ([aluminum]:[transition metal]) is in the range of 1:1 to about 100,000:1, and the more preferred ratio is 5:1 to 15,000:1.

The metallocene compound and the co-catalyst which constitute the catalyst composition of the present invention can be used in the gas phase, solution or slurry polymerization in the supported state into an inorganic oxide support (for example, silica, alumina, or silica-alumina mixture, clay, modified clay) or insoluble particle state thereof. Therefore, the catalyst composition of the present invention can be used in all the gas phase, solution or slurry polymerization of olefin, and the polymerization conditions for each process can be varied according to the type of the metallocene compound, the state of catalyst comprising metallocene/co-catalyst/support, polymerization method (gas phase, solution or slurry polymerization), and the desired properties of the polymerization product. As the porous support to deposit the metallocene compound and co-catalyst, stable particle in which a plurality of pores are formed, for example, inorganic oxide or inorganic salt can be used. Practically useful support is an inorganic oxide of element of Group II, III, IV of the Periodic Table, preferably silica, alumina, silica-alumina, or mixtures thereof, the more preferably silica having a spherical shape. The support is used in the form of a dried powder, and the average particle size is about 1 to 250 μm, preferably 10 to 150 μm, The surface area is about 5 to 1200 m²/g, preferably about 50 to 500 m²/g. The volume of the pore of the support is 0.1 to 5 cm³/g, preferably 0.1 to 3.5 cm³/g, and the pore size is about 50 to 500 Å, preferably 75 to 400 Å. Water or hydroxy group in the inorganic oxide support should be removed before use. Therefore, the support is heated at 100 to 800° C., preferably at 200 to 600° C. while flowing the support in vacuum or nitrogen atmosphere to remove water or hydroxy group in the support. The preferable amount of the hydroxy group on the surface of the support is about 0 to 3 mmol per 1 g of silica, more preferably 0.5 to 2.5 mmol per 1 g of silica, and the amount of the hydroxy group depends on the dehydration or calcination temperature of the support. Even though there are some variations according to the type of the silica, 0.7 to 1.5 mmol of hydroxy group is remained per 1 g of silica when calcining the support at 600° C., and 0.5 to 1.2 mmol of hydroxy group is remained when calcining at 800° C.

Hereinafter, the method for supporting the metallocene compound and the co-catalyst, which constitute the catalyst composition of the present invention, into a support will be described.

Firstly, the one or more metallocene compounds and the one or more co-catalysts are dissolved in a solvent to produce a metallocene solution, a co-catalyst solution or the mixture thereof. Exemplary solvent for this purpose includes saturated aliphatic hydrocarbon, such as pentane, hexane, heptane, cyclopentane, methylcyclopentane, cyclohexane, benzene, toluene, xylene, cumene, and isoparaffine, aromatic hydrocarbon, and cyclohydrocarbon, and the preferable solvent is toluene. Then, the obtained solution are mixed with a silica support having a pore size of about 50 to 500 Å and a pore volume of about 0.1 to 5.0 cm³/g to produce a slurry solution, and an acoustic wave or an oscillatory wave of high frequency, preferably 1 to 10,000 kHz frequency, is applied at 0 to 150° C. for 1 to 6 hours to uniformly disperse the metallocene compound and the co-catalyst, aluminoxane, into the micropores of the support. The acoustic wave or the oscillatory wave is preferably ultrasonic vibration wave, and more preferably has the frequency of 20 to 500 kHz. If the frequency of the oscillatory wave is too low, the catalyst cannot be sufficiently deposited into the support, and if the frequency of the oscillatory wave is too high, the support is liable to be destroyed. The oscillatory wave facilitates the mass transfer by a wave motion, and minutely agitates the materials to be supported in the pores of the support.

If necessary, Lewis acid or other additives can be dissolved with the metallocene compound. The Lewis acid can be commercially obtained, and represented by chemical formula RpMeXq, (RBO)₃, or [(RO)BO]₃, wherein R is a hydrocarbyl radical, preferably a hydrocarbyl radical having 1 to 10 carbon atoms, Me is selected from the group consisting of Mg, Al, B, and Zn, B is a boron atom, and X is hydrogen or halogen. In addition, p is 1, 2, or 3, q is 0, 1 or 2, and p+q is same with the atomic valence of Me. The preferable Lewis acid includes butylmagnesium chloride, dimethylmagnesium, diethylmagnesium, dibutylmagnesium, dimethylaluminum chloride, diethylaluminum chloride, diethylaluminum hydride, ethylaluminum dichloride, trimethylboroxine, triethylboroxine, tripropylboroxine, tributylboroxine, trimethoxyboroxine, triethoxyboroxine, triethylboron, dibutylboron chloride, triphenylboron, trimethylaluminum, triethylaluminum, triisopropylaluminum, triisobutylaluminum, trihexylaluminum, and so on. The more preferable Lewis acid includes trimethylaluminum, triethylaluminum, triisobutylaluminum, trimethylboroxine, triethylboroxine, and trimethoxyboroxine.

After applying the acoustic wave or the oscillatory wave, the supported metallocene catalyst is preferably washed with a hydrocarbon selected from the group consisting of pentane, hexane, heptane, isoparaffine, toluene, xylene and the mixtures thereof, and dried in vacuum or in nitrogen flow to produce the free-flowing catalyst of the solid powder state

An alternative method for producing the supported metallocene catalyst according to the present invention will be described hereinafter. Firstly, the co-catalyst, aluminoxane solution, is added to a dehydrated support to produce a slurry solution, and the acoustic wave or the oscillatory wave having the frequency of 1 to 10,000 kHz is applied. By washing the slurry solution with excess solvent, the co-catalyst treated support is produced. The treated support and one or more metallocene compounds in a powder state are uniformly mixed, and a solvent is added thereto to produce a slurry solution. At this time, the order of addition of the co-catalyst, metallocene compound and/or the solvent can be changed, if necessary. Then, the acoustic wave or the oscillatory wave having the frequency of 1 to 10,000 kHz is again applied to uniformly disperse the metallocene compound into the minute pores of the co-catalyst treated support. The produced supported metallocene catalyst is washed with a hydrocarbon solvent and dried before use.

As another alternative method for producing the supported catalyst composition according to the present invention, the metallocene compound, aluminoxane solution as the co-catalyst, and/or Lewis acid are mixed, and the acoustic wave or the oscillatory wave having the frequency of 1 to 10,000 kHz is applied to produce an uniformly dissolved and activated metallocene catalyst solution. Then, the activated metallocene catalyst solution is added to a support having pores, or the support is added to the solution to produce a slurry or a mud state solution, and then the acoustic wave or the oscillatory wave having the frequency of 1 to 10,000 kHz is applied to deeply penetrate and uniformly disperse each catalyst component, i.e., the metallocene compound, the co-catalyst solution, Lewis acid, or the like, into the pores of the support. By these methods, the formation of the agglomerate of the supported catalyst can also be prevented. The produced supported metallocene catalyst is washed with a hydrocarbon solvent and dried before use.

As another alternative method for producing the supported catalyst composition according to the present invention, the supported catalyst is produced with two kinds of the metallocene compounds, the co-catalyst and the support. In this case, the supported catalyst is produced by the following two steps. Firstly, the first metallocene compound is dissolved in a co-catalyst solution to produce an ativated catalyst solution, and the second metallocene compound is dissolved in a co-catalyst solution to produce an activated catalyst solution. The first activated catalyst solution is added to a porous support, or the porous support is added to the first activated catalyst solution. The mixture of the porous support and the catalyst solution is in the state like a slurry or a mud. Then the acoustic wave or the oscillatory wave is applied to the mixture for a predetermined time, and the second activated catalyst solution is a dded thereto, and the acoustic wave or the oscillatory wave is again applied to the mixture for a predetermined time. If necessary, a solution including Lewis acid can be added to the mixture. Finally, the produced supported metallocene catalyst is washed with a hydrocarbon solvent and dried before use. The preferable temperature of the supporting process is 0 to 100° C., more preferably 10 to 80° C., and the contact or the mixing time of the catalyst components is not critical, but preferably 30 minutes to 24 hours, more preferably 1 to 5 hours. The produced metallocene catalyst composition is preferably dried in vacuum or in nitrogen atmosphere to produce the free flowing catalyst having the solid powder state. The dried metallocene catalyst composition can include small amount of the residual solvent, for example, toluene of the co-catalyst solution, in the pores of the support, but preferably the metallocene catalyst composition is dried to remove all of the solvent.

In the supported metallocene catalyst produced by applying the acoustic wave or the oscillatory wave, the metallocene compound and the co-catalyst are uniformly penetrated into the micropore of the support, and uniformly dispersed through the overall space of the support. The amounts of the metallocene compound and the co-catalyst which can be deposited into the support depend on the pore volume of the support. The preferable amount of the transition metal of the metallocene compound deposited in a support is 0.1 to 5.0 wt % of the total weight of the supported catalyst, more preferably 0.2 to 2.0 wt %. The preferable amount of aluminum of the co-catalyst deposited in the support is 1 to 40 wt % of the total weight of the supported catalyst, more preferably 3 to 35 wt %, and most preferably 5 to 30 wt %. The molar ratio of aluminum of the co-catalyst in the supported catalyst and the transition metal of the metallocene compound in the supported catalyst (Al: transition metal) is 1:1 to 500:1, preferably 10:1 to 300:1, more preferably 40:1 to 250:1. For the better activity in solution polymerization, the ratio of Al: transition metal can be controlled to about 50:1 to 15,000:1. The supported metallocene catalyst composition according to the present invention has a high activity with the reduced amount of the co-catalyst, which reduces the catalyst cost for the industrial and commercial application. If Lewis acid is used for the supported metallocene catalyst composition according to the present invention, the amount of the Lewis acid is about 0.1 to 20 mol per 1 mol of the metallocene compound, preferably 0.5 to 5.0 mol, more preferably 0.8 to 1.5 mol.

The metallocene catalyst composition of the present invention can be used for polymerization of ethylene in the supported form with aluminoxane co-catalyst in the presence of various other olefins (α-olefins). The α-olefins are conventionally introduced to produce a low-density polyolefin, and ethylene/α-olefin co-polymer having a desired density can be obtained by adjusting the ratio of ethylene and α-olefin. The α-olefin represents an α-olefin hydrocarbon having 2 to 12 carbon atoms, preferably 3 to 10 carbon atoms, for examples, propylene, butene-1, pentene-1, 3-methylbutene-1, hexene-1, 4-methylpentene-1, 3-methylpentene-1, heptene-1, octene-1, decene-1, 4,4-dimethyl-1-pentene, 4,4-diethyl-1-hexene, 3,4-dimethyl-1-hexene, derivatives thereof, and the mixtures thereof. As previously described, if the α-olefin is introduced, the low-density polyolefin is conventionally obtained. However, when the catalyst composition according to the present invention is used for the polymerization, the activity of the catalyst is maintained even if the α-olefin is introduced, which results in the production of low-density and high molecular weight polyolefin. Meanwhile, the molecular weight of the polyolefin is conventionally controlled by changing the polymerization temperature or by introducing hydrogen into the reactor. The hydrogen for controlling the molecular weight of the polyolefin generally decreases an activity of the catalyst. However, the catalyst composition according to the present invention has characteristics of the increase of catalytic activity even when such hydrogen is introduced.

The olefin polymerization is carried out in the presence of liquid diluent or gas phase diluent, and the diluent must be non-reactive and does not have mal-effect on the catalyst system. Exemplary diluent includes nitrogen, methane, ethane, propane, butane, isobutane, pentane, hexane, heptane, octane, cyclohexane, methylcyclohexane, toluene, xylene, derivatives thereof, and the mixtures thereof. Before olefin polymerization, it is also preferable to remove the catalyst poisons which may present in the diluent. The temperature for the olefin polymerization can be varied according to reaction materials, reaction conditions, or the like, and the polymerization temperature is preferably in the range of about 20 to 200° C. and the polymerization pressure is preferably in the range of about 10 psig to 7000 psig. The polymerization using the catalyst composition according to the present invention can be carried out by single polymerization step or by the combination of prepolymerization step and main-polymerization step. The prepolymerization temperature is 0 to 80° C., preferably 10 to 60° C., and the main-polymerization temperature is 60 to 100° C., preferably 60 to 90° C. The gas phase polymerization using the catalyst composition according to the present invention can be carried out by performing the prepolymerization in a slurry state, and then performing the main-polymerization in gas phase. In this case, the prepolymerization temperature is 10 to 60° C., preferably 10 to 50° C., and the gas phase main-polymerization temperature is 60 to 100° C., preferably 60 to 90° C. The gas phase polymerization can be carried out without the prepolymerization. In this case, the gas phase main-polymerization temperature is 60 to 100° C., preferably 70 to 90° C.

Hereinafter, the preferable examples are provided for better understanding of the present invention. However, the present invention should not be restricted to the following Examples. In the following examples, the metallocene compound was produced with the Schlenk technique, in which air and moisture are completely removed and purified and dried nitrogen is used as an inert gas. Solvents were dried with metal sodium in the inert nitrogen atmosphere. Dichloromethane was dried with calcium hydride. Deuterated solvent for the Nuclear Magnetic Resonance (NMR) spectroscopy was kept with molecular sieve and used at need.

### MANUFACTURING EXAMPLE 1

### Preparation of (Cyclopentylcyclopentadienyl) (Cyclopentadienyl) Zirconium Dichloride

Cyclopentylbromide (137 g, 919 mmol) was dissolved in 300 ml of tetrahydrofuran solvent in a 2000 ml round bottom flask under nitrogen atmosphere, and the solution was stirred and cooled down in an ice-water bath to 0° C. 460 ml of sodium cyclopentadienide (2.0M tetrahydrofuran solution) was added to the solution for 60 minutes, and then the mixture was allowed to room temperature, and stirred overnight. The solvent was removed in vacuo, and the residue was extracted with hexane and filtered. From the result of gas chromatography analysis, it is confirmed that total 102 g of cyclopentylcyclopentadiene(78%) and dicyclopentylcyclopentadiene isomer (15%) having two cyclopentyl ligands was obtained. By vacuum distillation of the obtained product, 65 g of pure cyclopentylcyclopentadiene was obtained (yield: 52.7%). The obtained compound was introduced into a flask, and dissolved with 400 ml of tetrahydrofuran, and the solution was cooled to −78° C. Then, 296 ml of n-butyl lithium (1.6M hexane solution) was added for about 1 hour, the temperature was slowly warmed to room temperature and the mixture was stirred for 3 hours.

124.3 g of CpZrCl₃ (Cp is a cyclopentadienyl ligand.) was introduced into a flask, 300 ml of hexane was added thereto, and the solution was cooled to −78° C. While stirring the solution, 200 ml of tetrahydrofuran was added, and the temperature was slowly warmed to room temperature. The mixture in the first flask was slowly transferred to the mixture in the second flask at 0C. The mixture was warmed to room temperature where it was stirred overnight. After removing the solvent under vacuum, the residue was extracted with 300 ml of dichloromethane and filtered, and the solvent was removed from the filtrate. 1000 ml of hexane was added to the reaction product to form a slurry. The slurry was filtered, washed with 500 ml of hexane, and dried under vacuum to obtain 120 g of (cyclopentylcyclopentadienyl)(cyclopentadienyl) zirconium dichloride, which shows the 1H NMR (CDCl₃, ppm) data: 6.46(s,5H), 6.25-6.33(m,4H), 3.20˜3.14(m,1H), 1.48-2.06(m,8H)

### MANUFACTURING EXAMPLE 2

### Preparation of (1,2/1,3-methylcyclopentyl Cyclopentadienyl)(Cyclopentadienyl) Zirconium Dichloride

8 g (99.85 mmol) of methylcyclopentadiene obtained by pyrolyzing and distilling methylcyclopentadiene dimer was introduced into a flask, 200 ml of tetrahydrofuran was added thereto, and the mixture was cooled to −78° C. while stirring. Then 62.4 ml of n-butyl lithium (1.6M hexane solution) was added slowly, the temperature was warmed to room temperature, and the mixture was stirred for 2 hours. The reaction flask was cooled to 0° C., and 14.9 g of cyclopentyl bromide was slowly added thereto, and stirred overnight. The solvent was removed under vacuum, and the residue was extracted with hexane and filtered. And then the solvent was removed again and by vacuum distillation 3.4 g of 1,2/1,3-methylcyclopentylcyclopentadiene(yield: 37.3%) was obtained. The obtained compound was introduced into a flask, and 60 ml of tetrahydrofuran was added thereto, and the mixture was cooled to −78° C. while being stirred. Then 22.6 ml of n-butyl lithium (1.6M hexane solution) was added thereto for 30 minutes, the temperature was warmed to room temperature, and the solution was stirred for 3 hours.

9.5 g of CpZrCl₃ (Cp is a cyclopentadienyl ligand.) was introduced into a flask, 30 ml of hexane was added thereto, and the solution was cooled to −78° C. While stirring the solution, 30 ml of tetrahydrofuran was added, and the temperature was slowly elevated to room temperature. The mixture in the first flask was slowly transferred to the reaction mixture in the second flask at 0° C. The mixture was warmed to room temperature where it was stirred overnight. After removing the solvent under vacuum, the residue was extracted with 30 ml of dichloromethane and filtered, and the solvent was removed again. 150 ml of hexane was added to the reaction product to form a slurry. The slurry was filtered, washed with 30 ml of hexane, and dried under vacuum to obtain 10.5 g of (1,2/1,3-methylcyclopentylcyclopentadienyl) (cyclopentadienyl) zirconium dichloride (1/1 mixture) which shows the 1H NMR (CDCl₃, ppm) data: 6.43 and 6.44(s,5H), 5.97˜6.28(m,3H), 3.07(m,1 H), 2.23 and 2.17(s,3H), 1.1-2.02(m,8H)

### Example 1

### Preparation of Supported Catalyst of (Cyclopentyl Cyclopentadienyl)(Cyclopentadienyl) Zirconium Dichloride

15 ml of MAO (10% toluene solution, 4.64 wt % of Al) was added into 74 mg of the compound prepared in Manufacturing Example 1, and then the mixture was sonicated for 1 hour (sonication through oil bath). Under the nitrogen atmosphere, 4 g of silica (Grace D-948 grade), which was calcined for 12 hours at 250° C. to remove moisture and hydroxy group, was added to the mixture, and the mixture was sonicated again for 1 hour. After discarding a solvent, 40 ml of hexane was added thereto and the mixture was shaken for 5 minutes, and then the remaining solvent was discarded again. The process was repeated 5 times, and the supported catalyst was prepared by drying under vacuum. From the result of ICP-MS analysis of the supported catalyst, the content of Zr and Al were 0.31 wt % and 10.2 wt %, respectively.

### Example 2

### Preparation of Supported Catalyst of (1,2/1,3-methylcyclopentylcyclopentadienyl)(Cyclopentadienyl) Zirconium Dichloride

Except for using 77 mg of the compound prepared in Manufacturing Example 2, the supported catalyst was prepared according to the same method shown in Example 1. From the result of ICP-MS analysis of the supported catalyst, the content of Zr and Al were 0.3 wt % and 10.1 wt %, respectively.

### Comparative Example 1

### Preparation of Supported Catalyst of Bis(butylcyclopentadienyl) Zirconium Dichloride

Except for using 83 mg of bis(butylcyclopentadienyl) zirconium dichloride purchased from Crompton cooperation, the supported catalyst was prepared according to the same method shown in Example 1. From the result of ICP-MS analysis of the supported catalyst, the content of Zr and Al were 0.31 wt % and 9.94 wt %, respectively.

### Polymerization Example 1

### Ethylene/Hexene Slurry Co-polymerization by Using a Supported Catalyst

1 liter stainless-steel autoclave reactor, which was equipped with a jacket for providing cooling water from outside in order to control the polymerization temperature, was purged one time with propane and five times with ethylene at 85° C. to remove impurities, and then the temperature was reduced to room temperature. 400 ml of propane and 1.0 mmol of triisobutylaluminum were added to the 1 liter high pressure reactor, and stirred at 70° C. Then, 100 ml of propane and the predetermined amount of supported catalyst prepared in Examples 1 and 2 and Comparative Example 1 were added to the reactor, and ethylene and 37 ml of 1-hexene were added thereto so that the partial pressure of ethylene was 120 psig. Then, polymerization was carried out at 70° C. for 30 to 60 minutes while maintaining the overall pressure of reactor at 490 psig. After polymerization reaction was completed, the unreacted 1-hexene and propane were vented. Free flowing polymer was easily obtained by opening the reactor, and fouling was not observed when obtaining the product. The physical properties of the obtained polymer were shown in the table 1.

TABLE 1

| | | Amount | | | | | |
|---|---|---|---|---|---|---|---|
| | Amount | of | | | | | Density |
| | of | hydrogen | Polymerization | | | Melt | of |
| | catalyst | injection | time | Yield | | index | polymer |
| Catalyst system | (mg) | (cc) | (minute) | (g) | Activity | (g/10 min) | (g/cc) |
| Supported catalyst | 32 | 0 | 60 | 86.0 | 2.69 | 0.31 | 0.9188 |
| of Example 1 | | | | | | | |
| Supported catalyst | 28 | 50 | 60 | 90.0 | 3.21 | 1.36 | 0.9176 |
| of Example 1 | | | | | | | |
| Supported catalyst | 33 | 0 | 60 | 69.4 | 2.10 | 0.28 | 0.9167 |
| of Example 2 | | | | | | | |
| Supported catalyst | 29 | 50 | 60 | 73.1 | 2.52 | 1.28 | 0.9156 |
| of Example 2 | | | | | | | |
| Supported catalyst | 28 | 0 | 40 | 67.2 | 3.6 | 1.05 | 0.9167 |
| of Comp. Example | | | | | | | |
| Supported catalyst | 30 | 50 | 40 | 62.0 | 3.1 | 1.73 | 0.9161 |
| of Comp. Example | | | | | | | |

In Table 1, the activity represents the weight of polyolefin polymerized per unit time and per 1 g of catalyst at the ethylene partial pressure of 120 psig and at 70° C. (kgPE/ g·catalyst·hour), and the melt index and the density of polymer were measured by ASTM D1238 and ASTM D1505, respectively.

### Polymerization Example 2

### Ethylene/Hexene Continuous Gas Phase Fluidized Bed Polymerization by Using a Supported Catalyst

Preparation of Supported Catalyst

123.0 g (0.341mol) of (cyclopentylcyclopentadienyl)(cyclopentadienyl) zirconium dichloride and 22.0 kg of toluene solution including 10 wt % of methylaluminoxane (aluminum 4.62 wt %, density 0.88 g/mL, Albemarle) are mixed and stirred for 60 minutes at 40° C. to form a solution. 5.0 kg of Grace 948 silica, which was calcined for 12 hours at 350° C., was added to the solution, and an oscillatory wave having the frequency of 30 kHz was applied for 60 minutes at 40° C. while stirring the solution. Then the solvent was discarded by filtration, and the residual particle was washed 4 times with 20 L of hexane to obtain a solid catalyst. The obtained solid catalyst was dried with nitrogen for 4 hours at 40° C. to produce 8.0 kg of supported metallocene catalyst of free-flowing powder. From the result of ICP-MS analysis of the supported catalyst, the content of Zr and Al were 0.38 wt % and 12.0 wt %, respectively.

Continuous Gas Phase Fluidized Bed Polymerization

The gas phase polymerization was carried out with a continuous gas phase fluidized bed reactor of a pilot scale. The pilot polymerization reactor included two continuous, gas phase-fluidized bed reactors connected by series, and the first reactor had the volume of 1.2 m³, and the second reactor had the volume of 6 m³. Each fluidized bed reactor had a compressor for recirculating the unreacted reactants and the inert hydrocarbons, and a heat exchanger for removing reaction heat from the recirculated gas or for controlling the polymerization temperature, and a series of controller for controlling reactor temperature, pressure and the level of the fluidized bed. The fluidized bed consisted of the polymer particles, and the height of the fluidized bed was controlled by several control valves which actuated by signals from a differential pressure level gauge and/or a radioactive level gauge.

Ethylene, hydrogen, and co-monomer were introduced into the upper zone of the fluidized bed, passed through the heat exchanger and the compressor, and supplied into the bottom side of the fluidized bed. An inert propane gas was introduced to the upper side of the fluidized bed and the front side of the compressor. The flow rate of the ethylene, hydrogen, and co-monomer were separately controlled to maintain each target concentrations in the reactor uniformly. The concentration of the recirculation gases were measured with online gas chromatography to maintain the concentrations of the gases in the recirculated gas stream uniformly. The catalyst was continuously introduced into a pre-contacting reactor filled with liquid phase propane, and mixed with the liquid phase propane in the pre-contacting reactor. The catalyst and the liquid phase propane were introduced to the upper zone of the fluidized bed of the first reactor. The polymerized fluff grown by the polymerization in the first reactor was supplied to the upper side of the second reactor through a series of valves which was controlled by a fluidized bed level gauge. The polymer granule grown in the second reactor entered through a series of valves which was controlled by a fluidized bed gauge into the steamer for removing the unreacted reactants and hydrocarbon in the polymerized granule and for deactivating the catalyst. After the polymer fluff resided for the residence time in the steamer, it was transferred to the dryer and then packaged in a flecon. The height of the each fluidized bed reactor was constant maintained by the constant catalyst feeding rate and by transferring the produced amount of the polymer in the each reactor to the next treating step. The reaction zone where the size of the polymerizing particle increased was fluidized by the continuous gas flow of the supplying reactants and recirculating gases. The pressure of each reactor was controlled by a pressure transmitters and control valves attached on the each reactor. The pressure of the first reactor was maintained higher by 28 psig than the pressure of the second reactor to easily transfer the polymerized granule. In order to maintain the temperature of the reactor uniformly, the temperature of the recirculating gases was continuously controlled up or down to offset the difference of the heat by the polymerization reaction. Triisobutylaluminum(TIBAL) was diluted with hexane to 10 wt %, and fed to the precontacting reactor with the catalyst, and the feeding rate of TIBAL was controlled to be TIBAL/CATALYST=2 in weight. The catalyst was supplied with a rate of 30 g/hr, and the polymerization was carried out according to the conditions shown in Table 2. The properties of the obtained polymer also listed in Table 2. During the polymerization in the continuous gas phase fluidized bed reactor, the fouling of the polymer or the plugging of the reactor were not shown, and the polymerization was carried out stably.

### Comparative Example 2

### Ethylene/Hexene Continuous Gas Phase Fluidized Bed Polymerization by Using a Supported Catalyst

Preparation of Supported Catalyst

107.8 g (0.252 mol) of bis(cyclopentylcyclopentadienyl) zirconium dichloride and 16.44 kg of toluene solution including 10 wt % of methylaluminoxane (aluminum 4.62 wt %, density 0.88 g/mL, Albemarle) are mixed and stirred for 60 minutes at 40° C. to form a solution. 3.7 kg of Grace 948 silica, which was calcined for 12 hours at 350° C., was added to the solution, and an oscillatory wave having the frequency of 30 kHz was applied for 60 minutes at 40° C. while stirring the solution. Then the solvent was discarded by filtration, and the residual particle was washed 3 times with 20 L of hexane to obtain a solid catalyst. The obtained solid catalyst was dried with nitrogen for 4 hours at 40° C. to produce 5.95 kg of supported metallocene catalyst in the state of a minute and uniform powder having free flowing property. From the result of ICP-MS analysis of the supported catalyst, the content of Zr and Al were 0.36 wt % and 13.85 wt %, respectively.

Continuous Gas Phase Fluidized Bed Polymerization

The same continuous gas phase fluidized bed reactor of Polymerization Example 2 and the same polymerization method were used to carry out the polymerization. The polymerization was performed according to the conditions shown in Table 2. The properties of the obtained polymer also listed in Table 2.

TABLE 2

| | | | Poly- | |
|---|---|---|---|---|
| Conditions | | | merization | Comparative |
| Item | | Unit | Example 2 | Example 2 |
| The first | Temperature | ° C. | 73 | 72 |
| gas | Pressure | kg/cm² | 23 | 23 |
| phase | Bed weight | Kg | 120 | 120 |
| reactor | Ethylene conc. | mol % | 50 | 50.5 |
| | Hydrogen conc. | mol % | 0.02 | 0.02 |
| | 1-hexene/(1-hexene + | mol ratio | 0.02 | 0.02 |
| | ethylene) | | | |
| | Catalyst productivity | Kg/kg | 2020 | 1250 |
| | Melt index(MI) | g/10 min | 1.3 | 1.26 |
| | Polymer density | g/cc | 0.917 | 0.917 |
| The | Temperature | C | 75 | 75 |
| second | Pressure | kg/cm² | 19 | 19 |
| gas | Bed weight | Kg | 250 | 250 |
| phase | Ethylene conc. | mol % | 66 | 65 |
| reactor | Hydrogen conc. | mol % | 0.03 | 0.03 |
| | 1-hexene/(1-hexene + | mol ratio | 0.03 | 0.08 |
| | ethylene) | | | |
| | Catalyst productivity | Kg/kg | 1430 | 1000 |
| | Melt index (MI) | g/10 min | 1.2 | 1.3 |
| | Polymer density | g/cc | 0.917 | 0.917 |

| | | | |
|---|---|---|---|
| Total Catalyst productivity | Kg/kg | 3450 | 2250 |

As shown in Table 2, polymer particle having the desired polymer density, melt index, molecular weight and spherical shape can be obtained with high yield by using the catalyst composition of the present invention, and by adjusting the concentrations of the co-monomer such as hexene for controlling the polymer density, and hydrogen for controlling the molecular weight. In addition, the activity of the catalyst of the present invention increases even when hydrogen is supplied to adjust the melt index of the polymer.

While the present invention has been described with respect to certain preferred embodiments and examples only, other modifications and variations may be made without departing from the spirit and scope of the present invention as set forth in the following claims.

What is claimed is

1. A catalyst composition for polymerizing olefins comprising:
an unsymmetrical unbridged metallocene compound represented by chemical formula 1; and
an alumoxane represented by chemical formula 2 or 3, wherein the metallocene compound and the aluminoxane are uniformly deposited on a porous support by using an oscillatory wave having the frequency of 20 to 500 kHz, and the activity of the catalyst composition increases when hydrogen is introduced in the polymerization of olefin.
[Chemical formula 1]
(R¹CpR²)(Cp′R³)MX₂
wherein, Cp is a cyclopentadienyl radical; Cp′ is a radical having a cyclopentadienyl moiety; R¹ is a radical selected from cyclohydrocarbyl radicals having 3 to 11 carbon atoms; R² and R³ are one or more substituents substituted on Cp and Cp′, respectively, and the substituents can be the same or different, and are hydrogen, phosphine, amino, alkyl, alkoxy, alkyl amino, dialkyl amino, alkoxy-alkyl, aryl, aryloxy-alkyl, alkenyl, alkylaryl, or arylalkyl radical having 1 to 20 carbon atoms; M is a transition metal of Group 4B, 5B, or 6B of the Periodic Table; and X can be the same or different, and is a radical selected from halogen, alkyl, aryl, alkenyl, alkylaryl, arylalkyl, alkoxy, and aryloxy radical having 1 to 20 carbon atoms. 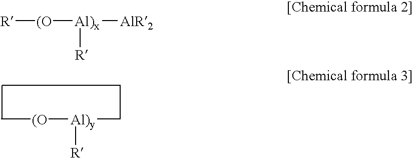
wherein, each R′ is the same or different and is a hydrocarbyl radical having 1 to 10 carbon atoms, x is an integer in the range of 1 to 50, and y is an integer in the range of 3 to 50.

2. The catalyst composition according to claim 1, wherein the M is a transition metal selected from the group consisting of titanium, zirconium, and hafnium, and the X is Cl.

3. The catalyst composition according to claim 1, wherein the (R¹CpR²) is a radical selected from the group consisting of (cyclopentyl cyclopentadienyl), (1-methyl-3-cyclopentyl cyclopentadienyl), (1-ethyl-3-cyclopentyl cyclopentadienyl), (1-butyl-3-cyclopentyl cyclopentadienyl), (cyclohexyl cyclopentadienyl), (1-methyl-3-cyclohexyl cyclopentadienyl), (1-ethyl-3-cyclohexyl cyclopentadienyl), (1-butyl-3-cyclohexyl cyclopentadienyl), (cyclohexylmethylenyl cyclopentadienyl), (cycloheptyl cyclopentadienyl), ((4-methylcyclohexyl)cyclopentadienyl), and (cyclohexylethylenyl cyclopentadienyl).

4. The catalyst composition according to claim 1, wherein the porous support is selected from the group consisting of silica, alumina, clay, modified clay, and the mixtures thereof.

5. The catalyst composition according to claim 1, further comprising Lewis acid deposited on the porous support.

6. The catalyst composition according to claim 5, wherein the Lewis acid is selected from the group consisting of butylmagnesium chloride, dimethylmagnesium, diethylmagnesium, dibutylmagnesium, dimethylaluminum chloride, diethylaluminum chloride, diethylaluminum hydride, ethylaluminum dichloride, trimethylboroxine, triethylboroxine, tripropylboroxine, tributylboroxine, trimethoxyboroxine, triethoxyboroxine, triethylboron, dibutylboron chloride, triphenylboron, trimethylaluminum, triethylaluminum, triisopropylaluminum, triisobutylaluminum, trihexylaluminum, and the mixtures thereof.

7. A process for olefin polymerization comprising the step of polymerizing ethylene with the catalyst composition of claim 1 in the presence of one or more co-monomer.

8. The process for olefin polymerization according to claim 7, wherein the step of polymerizing is carried out in the presence of hydrogen to control the molecular weight of the polymerized olefin.

9. The process for olefin polymerization according to claim 7, wherein the step of polymerizing is carried out by a method selected from the group consisting of solution polymerization, slurry polymerization and gas phase polymerization.
